(19) United States
(12) Patent Application Publication
(10) Pub. No.: US 2013/0080008 A1
(43) Pub. Date: Mar. 28, 2013

(54) CONTROL DEVICE OF VEHICLE CONTINUOUSLY VARIABLE TRANSMISSION

(71) Applicant: TOYOTA JIDOSHA KABUSHIKI KAISHA, Toyota-shi (JP)

(72) Inventors: Naoto TANAKA, Aichi-gun (JP); Shinya TOYODA, Nisshin-shi (JP); Makoto SAWADA, Nisshin-shi (JP); Yasunari MATSUI, Toyota-shi (JP)

(73) Assignee: TOYOTA JIDOSHA KABUSHIKI KAISHA, Toyota-shi (JP)

(21) Appl. No.: 13/627,324

(22) Filed: Sep. 26, 2012

(30) Foreign Application Priority Data
Sep. 27, 2011 (JP) 2011-211267

(51) Int. Cl. F16H 61/12

(52) U.S. Cl. 701/62

(57) ABSTRACT

A control device of a vehicle continuously variable transmission, includes a pair of variable pulleys consisting of an input-side variable pulley and an output-side variable pulley whose effective diameters are variable; a transmission belt wound around the pair of variable pulleys; an electromagnetic valve that controls an oil pressure fed to prevent a slip of the transmission belt; and an oil pressure sensor that detects the oil pressure controlled by the electromagnetic valve, wherein a sensor failure determination for determining whether a failure occurs in the oil pressure sensor is executed after execution of an electronic valve failure determination for determining whether a failure occurs in the electromagnetic valve.

### CROSS REFERENCE TO RELATED APPLICATION

The present application claims the benefits of Japanese Patent Application No. 2011-211267 filed Sep. 27, 2011, the disclosure of which is herein incorporated by reference in its entirety.

### BACKGROUND OF THE INVENTION

1. Field of the Invention

The present invention relates to a control device of a vehicle continuously variable transmission having a pair of variable pulleys whose effective diameters are variable and a transmission belt wound around the pair of variable pulleys.

2. Description of the Related Art

A vehicle continuously variable transmission (hereinafter, continuously variable transmission) is well known that has a pair of variable pulleys, i.e., an input-side variable pulley (primary pulley, primary sheave) and an output-side variable pulley (secondary pulley, secondary sheave) whose effective diameters are variable and a transmission belt wound around the pair of variable pulleys. An example thereof is a vehicle belt-type continuously variable transmission described in Japanese Laid-Open Patent Publication No. 6-213316. Such a continuously variable transmission is provided with, e.g., an electromagnetic valve (solenoid valve) that controls an oil pressure (e.g., belt clamping pressure) supplied to prevent the transmission belt from slipping, and an oil pressure sensor that detects the belt clamping pressure. In this continuously variable transmission, the belt clamping pressure is controlled based on a value of the belt clamping pressure detected by the oil pressure sensor. It is therefore desirable to properly determine whether the oil pressure sensor normally operates or not.

Japanese Laid-Open Patent Publication No. 6-213316 describes that for a failure of the oil pressure sensor whose output value is judged to be zero, the oil pressure sensor failure is detected by a diagnostic program that detects a disconnection, etc. Japanese Laid-Open Patent Publication No. 6-213316 further describes that for a failure of the oil pressure sensor that continues to output a certain value, the oil pressure sensor failure is determined based on output values from the oil pressure sensor and on whether a belt slip occurs or not.

By the way, the oil pressure sensor failure determination method described in Japanese Laid-Open Patent Publication No. 6-213316 depends on the assumption that the electromagnetic valve normally works that controls the belt clamping pressure to be detected by the oil pressure sensor. For example, in the case of determining an oil pressure sensor failure based on the output values from the oil pressure sensor and on whether a belt slip occurs or not, a comparison is made of the presence or absence of the belt slip upon the assumption that the electromagnetic valve normally works with the presence or absence of an actual belt slip, to thereby determine the failure in the oil pressure sensor. For this reason, in the event that there occurs an abnormal oil pressure reduction that a belt clamping pressure detection value obtained by the oil pressure sensor becomes lower by a given value or over than a belt clamping pressure target value thereof, it cannot possibly be discriminated whether the abnormality is attributable to a failure in the electromagnetic valve that reduces the actual belt clamping pressure or to a failure in the oil pressure sensor itself that the output value of the oil pressure sensor becomes lower than a proper value. The above problem is not publicly known and any proposal has not yet been made of the discrimination between the abnormal oil pressure reduction induced by the electromagnetic valve failure and the abnormal oil pressure reduction induced by the oil pressure sensor failure.

### SUMMARY OF THE INVENTION

The present invention was conceived in view of the above circumstances and it is an object thereof to provide a control device of a vehicle continuously variable transmission capable of preventing a false determination in an electromagnetic valve failure determination and an oil sensor failure determination.

### Means for Solving the Problems

To achieve the object, the first aspect of the present invention provides a control device of a vehicle continuously variable transmission, (a) comprising a pair of variable pulleys consisting of an input-side variable pulley and an output-side variable pulley whose effective diameters are variable; a transmission belt wound around the pair of variable pulleys; an electromagnetic valve that controls an oil pressure fed to prevent a slip of the transmission belt; and an oil pressure sensor that detects the oil pressure controlled by the electromagnetic valve, wherein (b) a sensor failure determination for determining whether a failure occurs in the oil pressure sensor is executed after execution of an electronic valve failure determination for determining whether a failure occurs in the electromagnetic valve.

### The Effects of the Invention

This allows the sensor failure determination to be carried out on the basis of the state where the presence/absence of a failure in the electromagnetic valve has been settled as a result of execution of the electromagnetic valve failure determination, so that it is determined in the state where the presence/absence of a failure in the electromagnetic valve has already been settled for example whether a failure in the oil pressure sensor brings about an abnormal that a detection value of the oil pressure from the oil pressure sensor is lower than a target value. A false determination can thus be prevented in the failure determination of the electromagnetic valve and the failure determination of the oil pressure sensor.

The second aspect of the present invention provides the control device of a vehicle continuously variable transmission recited in the first aspect of the present invention, wherein the electromagnetic valve failure determination determines whether a slip of the transmission belt occurs and, if the slip of the transmission belt is determined to occur, determines that a failure occurs in the electromagnetic valve. Consequently, it can be properly determined whether a failure occurs in the electromagnetic valve based on whether there occurs a slip of the transmission belt.

The third aspect of the present invention provides the control device of a vehicle continuously variable transmission recited in the second aspect of the present invention, wherein the electromagnetic valve failure determination determines whether a slip of the transmission belt occurs based on whether an actual value of a gear ratio of the vehicle continuously variable transmission deviates from a lowest-speed-side gear ratio in an acceleration running with the vehicle continuously variable transmission kept at the lowest-speed-side gear ratio. Consequently, it can be properly determined whether a slip of the transmission belt occurs.

The fourth aspect of the present invention provides the control device of a vehicle continuously variable transmission recited in any one of the first to third aspects of the present invention, wherein the sensor failure determination determines whether an oil pressure drop abnormality occurs that a detection value of the oil pressure from the oil pressure sensor is lower continuously for a predetermined period of time than a predetermined threshold value that is set to be a value lower by a given value than a target value of the oil pressure and, if it is determined in the electromagnetic valve failure determination that no failure occurs in the electromagnetic valve and if the oil pressure drop abnormality is determined to occur, determines that a failure occurs in the oil pressure sensor. Consequently, it can be definitely discriminated whether the oil pressure drop abnormality is attributable to a failure in the electromagnetic valve or to a failure in the oil pressure sensor. In other words, it can be definitely discriminated whether the oil pressure drop abnormality originates from a low-pressure-side failure in the electromagnetic valve that reduces the actual oil pressure or from a low-pressure-side failure of the oil pressure sensor itself that an output value from the oil pressure sensor is lower than the proper value. A false determination can thus be securely prevented in the failure determination of the electromagnetic valve and the failure determination of the oil pressure sensor.

### BRIEF DESCRIPTION OF THE DRAWINGS

FIG. 1 is a diagram explaining a schematic configuration of a vehicle to which the present invention is applied and is a block diagrammatic representation explaining a principal part of a control system disposed on the vehicle.

FIG. 2 is a hydraulic circuit diagram depicting a principal part associated with the shift control, etc., of the continuously variable transmission in the oil pressure control circuit.

FIG. 3 is a function block diagram explaining a principal part of control functions provided by the electronic control device.

FIG. 4 is a diagram depicting an example of a shift map used when a target input shaft rotation speed is obtained in the shift control of the continuously variable transmission.

FIG. 5 is a diagram depicting an example of a belt clamping pressure map for obtaining a target secondary pressure depending on the gear ratio, etc., in the belt clamping force control of the continuously variable transmission.

FIG. 6 is a diagram explaining a state which is an oil pressure drop abnormality.

FIG. 7 is a flowchart explaining major control actions of the electronic control device, i.e., control actions for preventing a false determination in the failure determination of the electromagnetic valve and the failure determination of the secondary pressure sensor.

### DESCRIPTION OF THE PREFERRED EMBODIMENT

In the present invention, an oil pressure control circuit is preferably configured so as to independently control oil pressures acting on the input-side variable pulley and on the output-side variable pulley. The oil pressure control circuit may otherwise be configured such that instead of directly controlling the oil pressure acting on the input-side variable pulley, the flowrate of a working oil to an oil pressure cylinder of the input-side variable pulley is controlled so as to generate a resultant oil pressure acting on the input-side variable pulley.

A preferred embodiment of the present invention will now be described with reference to the accompanying drawings.

### Embodiment

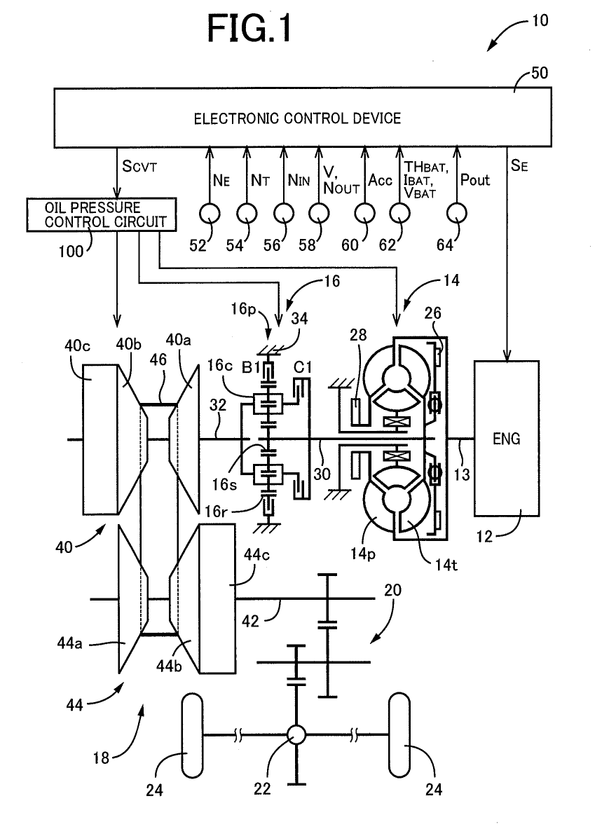

FIG. 1 is a diagram explaining a schematic configuration of a vehicle 10 to which the present invention is applied and is a block diagrammatic representation explaining a principal part of a control system disposed for controlling portions of the vehicle 10. Referring to FIG. 1, in the vehicle 10, a power output from an engine 12 acting as a source of driving force for motion is transmitted to left and right drive wheels 24 through in sequence a torque converter 14 as a fluid-type power transmission device, a forward/backward motion switching device 16, a belt-type continuously variable transmission (hereinafter, referred to as continuously variable transmission (CVT)) 18 as a vehicle continuously variable transmission, a speed reduction gear 20, a differential gear 22, etc.

The torque converter 14 is provided with a pump wheel 14p coupled to a crankshaft 13 of the engine 12 and a turbine wheel 14t coupled to the forward/backward motion switching device 16 by way of a turbine shaft 30 corresponding to an output-side member of the torque converter 14, to perform a power transmission through a fluid. A lock-up clutch 26 is disposed between the pump wheel 14p and the turbine wheel 14t. To the pump wheel 14p is coupled a mechanical oil pump 28 that generates a working oil pressure through the rotation drive of the engine 12, the working oil pressure serving to: control shifting of the continuously variable transmission 18; generate a belt clamping force in the continuously variable transmission 18; switch a power transmission path in the forward/backward motion switching device 16; and supply a lubricant to portions of the power transmission path of the vehicle 10.

The forward/backward motion switching device 16 is composed mainly of a forward clutch C1 and a backward brake B1 and a double-pinion planetary gear device 16p. The planetary gear device 16p includes a sun gear 16s integrally coupled to the turbine shaft 30 and a carrier 16c integrally coupled to an input shaft 32 of the continuously variable transmission 18. The carrier 16c and the sun gear 16s are selectively coupled to each other via the forward clutch C1, with a ring gear 16r of the planetary gear device 16p selectively secured via the backward brake B1 to a housing 34 that is a non-rotating member. The forward clutch C1 and the backward brake B1 are hydraulic frictional engagement devices.

In the forward/backward switching device 16 thus configured, when the forward clutch C1 is engaged and the backward brake B1 is released, the forward/backward switching device 16 is brought into an integrally rotating state so that the turbine shaft 30 is directly coupled to the input shaft 32 to establish (achieve) a forward power transmission path. When the backward brake B1 is engaged and the forward clutch C1 is released, the forward/backward switching device 16 establishes (achieves) a backward power transmission path so that the input shaft 32 is rotated in the opposite direction to the turbine shaft 30. When the forward clutch C1 and the backward brake B1 are both released, the forward/backward switching device 16 goes into a neutral state (power transmission cutoff state) to cut off the power transmission.

The continuously variable transmission 18 is provided with a pair of variable pulleys 40, 44, i.e., an input-side variable pulley (primary pulley, primary sheave) 40 having a variable effective diameter that is an input-side member disposed on the input shaft 32 and an output-side variable pulley (secondary pulley, secondary sheave) 44 having a variable effective diameter that is an output-side member disposed on the output shaft 42, and with a transmission belt 46 wound around the pair of variable pulleys 40 and 44, to transmit a power via a friction force between the pair of variable pulleys 40 and 44 and the transmission belt 46.

The primary pulley 40 includes a fixed rotator (fixed sheave) 40a that is an input-side fixed rotator fixed to the input shaft 32; a movable rotator (movable sheave) 40b that is an input-side movable rotator disposed on the input shaft 32 in such a manner as to be relatively unrotatable around its axis and axially movable; and an input-side hydraulic cylinder (primary-side hydraulic cylinder) 40c acting as a hydraulic actuator that applies an input-side thrust (primary thrust) Win (=primary pressure Pin×pressure receiving area) in the primary pulley 40 for changing a V-groove width therebetween. The secondary pulley 44 includes a fixed rotator (fixed sheave) 44a that is an output-side fixed rotator fixed to the output shaft 42; a movable rotator (movable sheave) 44b that is an output-side movable rotator disposed on the output shaft 42 in such a manner as to be relatively unrotatable around its axis and axially movable; and an output-side hydraulic cylinder (secondary-side hydraulic cylinder) 44c acting as a hydraulic actuator that applies an output-side thrust (secondary thrust) Wout (=secondary pressure Pout×pressure receiving area) in the secondary pulley 44 for changing a V-groove width therebetween.

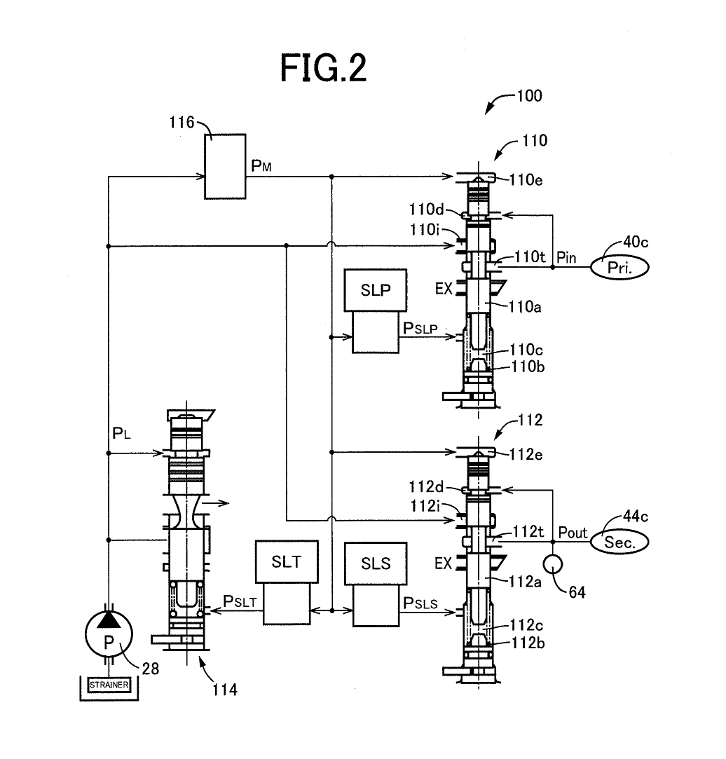

An oil pressure control circuit 100 (see FIG. 2) regulates and controls a primary pressure (shift pressure) Pin that is an oil pressure applied to the primary-side hydraulic cylinder 40c so that the V-groove widths of the pair of variable pulleys 40 and 44 vary to change an engagement diameter (effective diameter) of the transmission belt 46 to continuously vary a gear ratio γ (=input shaft rotation speed N_{N}/output shaft rotation speed N_{OUT}). The oil pressure control circuit 100 regulates and controls a secondary pressure (belt clamping pressure) Pout that is an oil pressure applied to the secondary-side hydraulic cylinder 44c so that friction forces (belt clamping forces) between the pair of variable pulleys 40 and 44 and the transmission belt 46 are controlled depending on the secondary pressure Pout so as not to cause a slip of the transmission belt 46.

In the continuously variable transmission 18, when the primary pressure Pin is increased for example, the V-groove width of the primary pulley 40 narrows so that the gear ratio γ reduces, i.e., the continuously variable transmission 18 is up-shifted. When the primary pressure Pin is reduced, the V-groove width of the primary pulley 40 widens so that the gear ratio γ increases, i.e., the continuously variable transmission 18 is down-shifted. Thus, at a point where the V-groove width of the primary pulley 40 is minimized, a minimum gear ratio γmin (maximum-speed-side gear ratio, Max_{Hi}) is formed as the gear ratio γ of the continuously variable transmission 18. At a point where the V-groove width of the primary pulley 40 is maximized, a maximum gear ratio γ max (minimum-speed-side gear ratio, Min_{LOW}) is formed as the gear ratio γ of the continuously variable transmission 18.

The vehicle 10 is mounted with an electronic control device 50 that includes a control device of the vehicle continuously variable transmission related to the shift control of the continuously variable transmission 18 for example. The electronic control device 50 is configured including a so-called microcomputer having e.g. a CPU, a RAM, a ROM, and an input/output interface. The CPU performs signal processing in accordance with a program stored in the ROM while utilizing a temporary storage function of the RAM, to execute various controls of the vehicle 10. For example, the electronic control device 50 is intended to execute output control of the engine 12, shift control of the continuously variable transmission 18, belt clamping force control, etc., and, if needed, is configured separately as engine control use, oil pressure control use of the continuously variable transmission 18, etc. The electronic control device 50 receives various input signals (e.g., an engine rotation speed N_{E}, a turbine rotation speed N_{T}, the input shaft rotation speed N_{IN} that is a rotation speed of the input shaft 32 as an input rotation speed of the continuously variable transmission 18, the output shaft rotation speed N_{OUT} that is a rotation speed of the output shaft 42 as an output rotation speed of the continuously variable transmission 18 corresponding to a vehicle velocity V, an accelerator opening Acc, a battery temperature TH_{BAT}, a battery charge/discharge current I_{BAT}, a battery voltage V_{BAT}, and the secondary pressure Pout) detected by sensors (e.g., an engine rotation speed sensor 52, a turbine rotation speed sensor 54, an input shaft rotation speed sensor 56, an output shaft rotation speed sensor 58, an accelerator opening sensor 60, a battery sensor 62, and a secondary pressure sensor 64) disposed on the vehicle 10. The electronic control device 50 feeds various output signals (e.g., an engine output control command signal S_{E} for output control of the engine 12 and an oil pressure control command signal S_{CVT} for oil pressure control associated with shifting of the continuously variable transmission 18) to the devices (e.g., the engine 12 and the oil pressure control circuit 100) disposed on the vehicle 10. The electronic control device 50 figures out in succession a charging state (charging capacity) SOC of the battery (storage device) based on the battery temperature TH_{BAT}, the battery charge/discharge current I_{BAT}, and the battery voltage V_{BAT} for example. The electronic control device 50 figures out in succession an actual gear ratio γ (=N_{IN}/N_{OUT}) of the continuously variable transmission 18 based on the output shaft rotation speed N_{OUT} and the input shaft rotation speed N_{IN} for example. The oil pressure control command signal S_{CVT} includes, e.g., a command signal for driving a linear solenoid valve SLP that controls the primary pressure Pin, a command signal for driving a linear solenoid valve SLS that controls the secondary pressure Pout, and a command signal for driving a linear solenoid valve SLT that controls a line oil pressure P_{L}.

FIG. 2 is a hydraulic circuit diagram depicting a principal part associated with the belt clamping force control, the gear ratio control, etc., of the continuously variable transmission 18 in the oil pressure control circuit 100. In FIG. 2, the oil pressure control circuit 100 is provided with, e.g., the oil pump 28, a primary pressure control valve 110 that regulates the primary pressure Pin fed to the primary-side hydraulic cylinder 40c for varying the gear ratio γ of the continuously variable transmission 18, a secondary pressure control valve 112 that regulates the secondary pressure Pout fed to the secondary-side hydraulic cylinder 44c for preventing the belt from slipping, a primary regulator valve 114 that regulates the line oil pressure P_{L}, a modulator valve 116 that regulates a modulator oil pressure P_{M}, the linear solenoid valve SLP that controls the primary pressure Pin, the linear solenoid valve SLS that controls the secondary pressure Pout, the linear solenoid valve SLT that controls the line oil pressure P_{L}, and the secondary pressure sensor 64 acting as an oil pressure sensor that detects the secondary pressure Pout.

Using a working oil pressure output from the oil pump 28 as a source pressure, the line oil pressure P_{L} is regulated by the primary regulator valve 114 of relief type into a value that depends on the engine load, etc., based on a control oil pressure P_{SLT} that is an output oil pressure from the linear solenoid valve SLT. For example, the line oil pressure P_{L} is regulated based on the control oil pressure P_{SLT} that is set so as to achieve an oil pressure obtained by adding a predetermined margin to a higher one of the primary pressure Pin and the secondary pressure Pout. It is thus possible in the pressure regulation actions of the primary pressure control valve 110 and the secondary pressure control valve 112 to obviate a shortage of the line oil pressure P_{L} that is a source pressure and to prevent an unnecessary rise of the line oil pressure P_{L}. The modulator oil pressure P_{M} serves as source pressures for the control oil pressure P_{SLT} that is controlled by the electronic control device 50, a control oil pressure P_{SLP} that is an output oil pressure from the linear solenoid valve SLP, and a control oil pressure P_{SLS} that is an output oil pressure from the linear solenoid valve SLS and is regulated by the modulator valve 116 into a certain pressure using the line oil pressure P_{L} as the source pressure.

The primary pressure control valve 110 includes: a spool valve element 110a axially movably disposed to open or close an input port 110i to allow the line oil pressure P_{L} to be fed from the input port 110i through an output port 110t into the primary-side hydraulic cylinder 40c; a spring 110b acting as a biasing means that biases the spool valve element 110a in a valve-opening direction; an oil chamber 110c that houses the spring 110b and receives the control oil pressure P_{SLP} to impart a thrust in the valve-opening direction to the spool valve element 110a; a feedback oil chamber 110d that receives the line pressure P_{L} output from the output port 110t to impart a thrust in a valve-closing direction to the spool valve element 110a; and an oil chamber 110e that receives the modulator oil pressure P_{M} to impart a thrust in the valve-closing direction to the spool valve element 110a. The primary pressure control valve 110 configured in this manner regulates and controls the line oil pressure P_{L} using the control oil pressure P_{SLP} for example as a pilot pressure, to feed to the primary-side hydraulic cylinder 40c. This allows the line oil pressure P_{L} to be fed as the primary pressure Pin to the primary-side hydraulic cylinder 40c. For example, when the control oil pressure P_{SLP} rises, the spool valve element 110a moves upward in FIG. 2 to increase the primary pressure Pin. On the contrary, for example, when the control oil pressure P_{SLP} lowers, the spool valve element 110a moves downward in FIG. 2 to reduce the primary pressure Pin. In this manner, the linear solenoid valve SLP functions as an electromagnetic valve that controls the primary pressure Pin. Since the line pressure P_{L} is a source pressure of the primary pressure Pin, the linear solenoid valve SLT functions as an electromagnetic valve that controls the primary pressure Pin.

The secondary pressure control valve 112 includes: a spool valve element 112a axially movably disposed to open or close an input port 112i to allow the line oil pressure P_{L} to be fed from the input port 112i through an output port 112t into the secondary-side hydraulic cylinder 44c; a spring 112b acting as a biasing means that biases the spool valve element 112a in a valve-opening direction; an oil chamber 112c that houses the spring 112b and receives the control oil pressure P_{SLS} to impart a thrust in the valve-opening direction to the spool valve element 112a; a feedback oil chamber 112d that receives the line pressure P_{L} output from the output port 112t to impart a thrust in a valve-closing direction to the spool valve element 112a; and an oil chamber 112e that receives the modulator oil pressure P_{M} to impart a thrust in the valve-closing direction to the spool valve element 112a. The secondary pressure control valve 112 configured in this manner regulates and controls the line oil pressure P_{L} using the control oil pressure P_{SLS} for example as a pilot pressure, to feed to the secondary-side hydraulic cylinder 44c. This allows the line oil pressure P_{L} to be fed as the secondary pressure Pout to the secondary-side hydraulic cylinder 44c. For example, when the control oil pressure P_{SLS} rises, the spool valve element 112a moves upward in FIG. 2 to increase the secondary pressure Pout. On the contrary, for example, when the control oil pressure P_{SLS} lowers, the spool valve element 112a moves downward in FIG. 2 to reduce the secondary pressure Pout. In this manner, the linear solenoid valve SLS functions as an electromagnetic valve that controls the secondary pressure Pout. Since the line pressure P_{L} is a source pressure of the secondary pressure Pout, the linear solenoid valve SLT functions as an electromagnetic valve that controls the secondary pressure Pout.

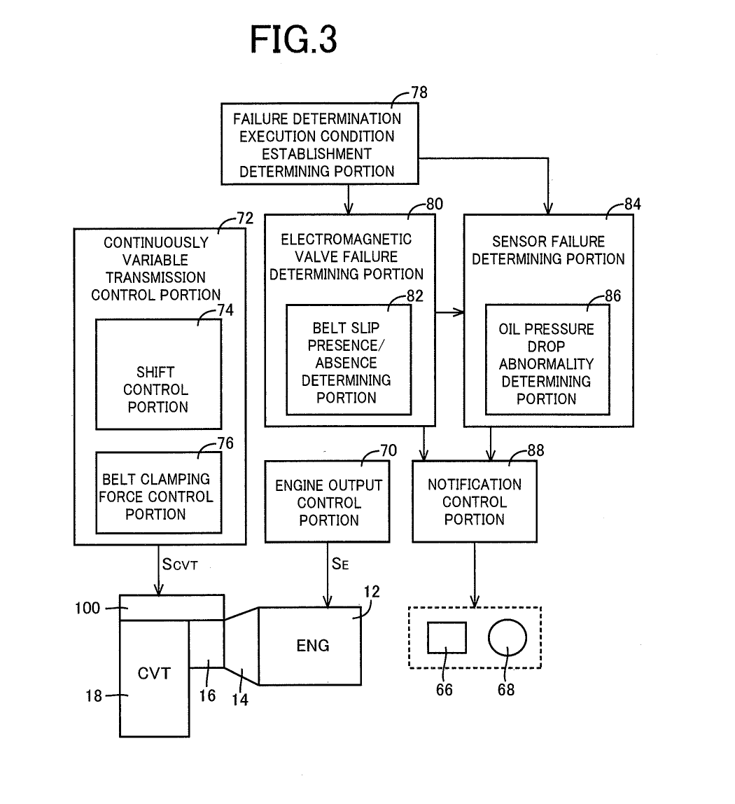

FIG. 3 is a function block diagram explaining a principal part of control functions provided by the electronic control device 50. In FIG. 3, an engine output control means, i.e., an engine output control portion 70 outputs, for the output control of the engine 12, engine output control command signals S_{E} such as a throttle signal, an injection signal, and an ignition timing signal to a throttle actuator, a fuel injector, and an igniter, respectively. For example, the engine output control portion 70 sets a target engine torque T_{E}* for acquiring a driving force (driving torque) corresponding to the accelerator opening Acc and, for achieving the target engine torque T_{E}*, not only controls opening/closing of an electronic throttle valve by the throttle actuator, but also controls the fuel injection amount by the fuel injector and controls the ignition timing by the igniter.

To achieve a target gear ratio γ* of the continuously variable transmission 18 while preventing the occurrence of a belt slip of the continuously variable transmission 18 for example, a continuously variable transmission control means, i.e., a continuously variable transmission control portion 72 determines a primary specified oil pressure Pintgt that is a command value (or a target primary pressure Pin*) of the primary pressure Pin and a secondary specified oil pressure Pouttgt that is a command value (or a target secondary pressure Pout*) of the secondary pressure Pout and outputs the primary specified oil pressure Pintgt and the secondary specified oil pressure Pouttgt as the oil pressure control command signals S_{CVT} to the oil pressure control circuit 100. Hence, the continuously variable transmission control portion 72 includes a shift control means, i.e., a shift control portion 74 that controls shifting of the continuously variable transmission 18 and a belt clamping force control means, i.e., a belt clamping force control portion 76 that controls a belt clamping force of the continuously variable transmission 18.

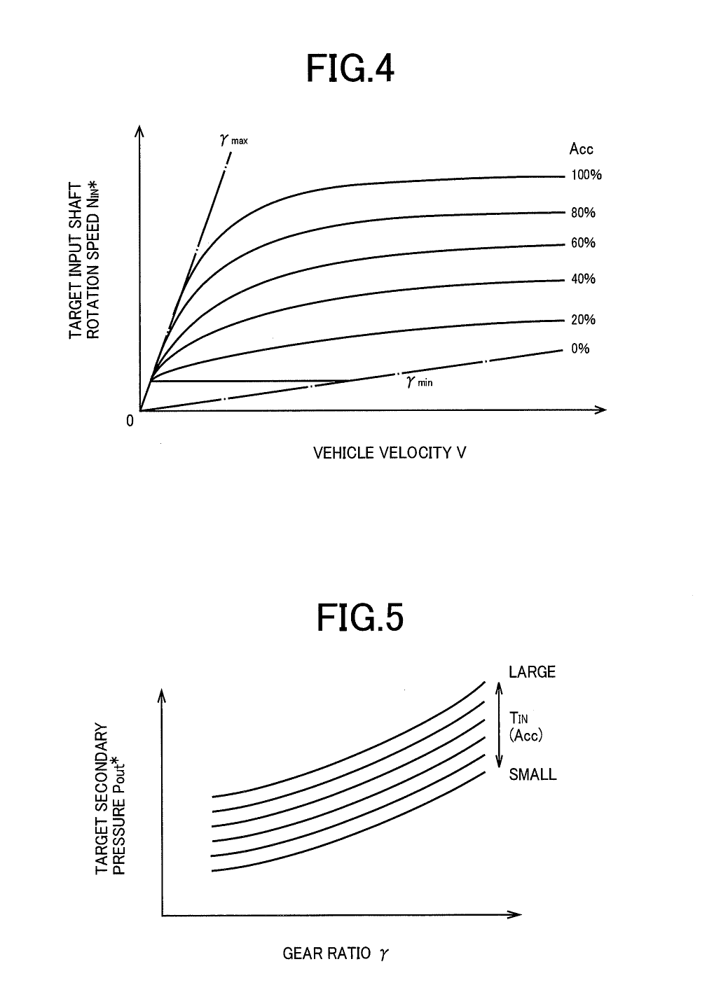

The shift control portion 74 sets a target input shaft rotation speed N_{IN}*, based on a vehicle status indicated by an actual vehicle velocity V and the accelerator opening Acc, from a relationship (a shift map) as depicted in FIG. 4 for example between the vehicle velocity V and the target input shaft rotation speed N_{IN}* of the continuously variable transmission 18 that is previously obtained and stored with the accelerator opening Acc as a parameter. Then, the shift control portion 74 executes a shift of the continuously variable transmission 18 by a feedback control for example, based on a rotation deviation ΔN_{IN}(=N_{IN}*−N_{IN}) between an actual input shaft rotation speed N_{IN} and the target input shaft rotation speed N_{IN}*, such that the actual input shaft rotation speed N_{IN} coincides with the target input shaft rotation speed N_{IN}*. Specifically, the shift control portion 74 determines a primary specified oil pressure Pintgt for regulating the primary pressure Pin so that the target input shaft rotation speed N can be obtained and outputs the primary specified oil pressure Pintgt to the oil pressure control circuit 100 to continuously vary the gear ratio γ. The shift map of FIG. 4 corresponds to shift conditions for satisfying both the drivability (engine performance) and the fuel efficiency (fuel consumption performance) for example and sets a target input shaft rotation speed N_{IN}* providing a larger gear ratio γ according as the accelerator opening Acc increases with a less vehicle velocity V. The target input shaft rotation speed N_{IN}* corresponds to the target gear ratio γ*(=N_{IN}*/N_{OUT}) and is defined within a range between a minimum gear ratio γmin of the continuously variable transmission 18 and a maximum gear ratio γmax.

The belt clamping force control portion 76 sets a target secondary pressure Pout*, based on a vehicle status indicated by an actual gear ratio γ and an input torque T_{IN}, from a relationship (a belt clamping pressure map) as depicted in FIG. 5 for example between the gear ratio γ and the target secondary pressure Pout* corresponding to the belt clamping force that is previously obtained and stored with the input torque T_{IN} of the continuously variable transmission 18 (or the accelerator opening Acc, the throttle valve opening, etc.) as a parameter. Then, the belt clamping force control portion 76 executes a feedback control for causing a sensor detected pressure PoutS corresponding to a detection value of the actual secondary pressure Pout detected by the secondary pressure sensor 64 to coincide with the target secondary pressure Pout*. Specifically, the belt clamping force control portion 76 determines a secondary specified oil pressure Pouttgt for regulating the secondary pressure Pout so that the target secondary pressure Pout* can be obtained and outputs the secondary specified oil pressure Pouttgt to the oil pressure control circuit 100 to increase or decrease the belt clamping force. A belt clamping force map of FIG. 5 corresponds to control conditions for applying to the pair of variable pulleys 40 and 44 a belt clamping force causing no belt slip and not having an excessive magnitude for example.

The oil pressure control circuit 100 regulates the primary pressure Pin by operating the linear solenoid valve SLP so that the shift of the continuously variable transmission 18 is executed in accordance with the primary specified oil pressure Pintgt and regulates the secondary pressure Pout by operating the linear solenoid valve SLS so that the belt clamping force is increased or decreased in accordance with the secondary specified oil pressure Pouttgt.

The continuously variable transmission control portion 72 figures out the input torque T_{IN} of the continuously variable transmission 18 as a torque (=T_{E}×t) obtained by multiplying an engine torque T_{E} by a torque ratio t of the torque converter 14 (=turbine torque T_{T}/pump torque T_{P}) for example. The continuously variable transmission control portion 72 figures out an estimated value of the engine torque T_{E}, based on an actual intake air amount and the engine rotation speed N_{E}, from a relationship (an engine torque map) between the engine rotation speed N_{E} and the engine torque T_{E} that is previously experimentally obtained and stored with an intake air amount (or throttle valve opening, etc.) as a parameter for example. The continuously variable transmission control portion 72 figures out the torque ratio t, based on an actual speed ratio e, from a relationship (an operating characteristic diagram of the torque converter) between a speed ratio e of the torque converter 14 (=turbine rotation speed N_{T}/pump rotation speed N_{P}) and the torque ratio t that is previously experimentally obtained and stored for example.

It is herein desired to detect an abnormality caused by a failure of a device affecting the vehicle running and to identify the failed device. It is desired for example to detect an abnormality of the secondary pressure Pout affecting the belt clamping force and the shift of the continuously variable transmission 18 and to identify a failed device. In particular, this embodiment examines a case of occurrence of an oil pressure drop abnormality where a detection value (a sensor detected pressure PoutS) of the secondary pressure Pout obtained by the secondary pressure sensor 64 becomes lower than the target secondary pressure Pout*.

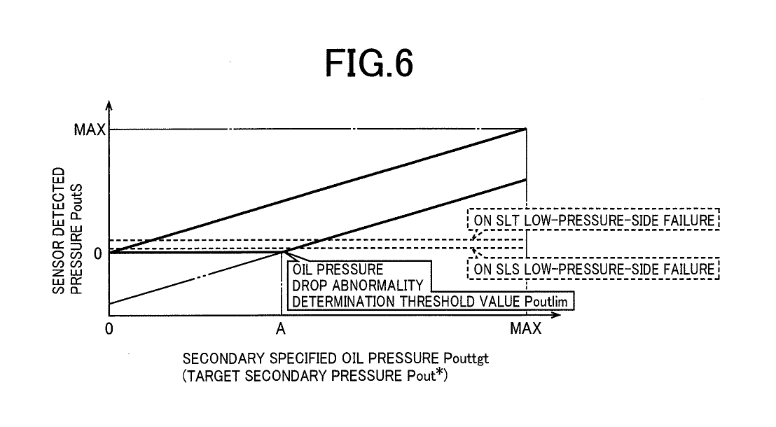

The oil pressure drop abnormality refers to e.g., a state where the sensor detected pressure PoutS corresponding to the secondary specified oil pressure Pouttgt is lower than an oil pressure drop abnormality determination threshold value Poutlim as depicted in FIG. 6. This oil pressure drop abnormality determination threshold value Poutlim is a predetermined threshold value that is previously obtained and set to be, e.g., a value lower by a given value than the target secondary pressure Pout* (secondary specified oil pressure Pouttgt). This predetermined value is an oil pressure dispersion of the actual secondary pressure Pout relative to the target secondary pressure Pout* that is previously experimentally obtained by taking account of the oil pressure control accuracy and the oil temperature difference in the oil pressure control circuit 100.

By the way, considered as a cause inducing the oil pressure drop abnormality is a failure of the secondary pressure sensor 64, i.e., a low-pressure-side failure of the secondary pressure sensor 64 itself where the sensor detection pressure value PoutS becomes lower than a proper value (actual secondary pressure Pout) although there occurs an actual secondary pressure Pout corresponding to the target secondary pressure Pout*. Considered as another cause inducing the oil pressure drop abnormality is a failure in the linear solenoid valve SLT or the linear solenoid valve SLS (hereinafter, electromagnetic valve SLT, SLS) as depicted in FIG. 6, i.e., a low-pressure-side failure of the electromagnetic valve SLT or SLS that lowers the actual secondary pressure Pout (prevents the actual secondary pressure Pout from being produced). For this reason, it cannot possibly be definitely discriminated whether the oil pressure drop abnormality arises from the low-pressure-side failure of the electromagnetic valve SLT or SLS or from the low-pressure-side failure of the secondary pressure sensor 64 itself. It may become difficult to identify a failed device to inform the user (driver) thereof.

Thus, the electronic control device 50 of this embodiment executes an electromagnetic valve failure determination for determining whether a failure occurs in the electromagnetic valve SLT, SLS and thereafter executes a sensor failure determination for determining whether a failure occurs in the secondary pressure sensor 64. In other words, the electronic control device 50 executes the sensor failure determination after the determination of the presence or absence of the failure in the electromagnetic valve SLT, SLS.

More specifically, referring back to FIG. 3, a failure determination execution condition establishment determining means, i.e., a failure determination execution condition establishment determining portion 78 determines whether the vehicle is in acceleration running with the gear ratio γ of the continuously variable transmission 18 kept at a maximum gear ratio γmax for example. This determination is made to see if the running state is liable to cause a belt slip of the continuously variable transmission 18 attendant on the occurrence of the oil pressure drop abnormality arising from the low-pressure-side failure of the electromagnetic valve SLT, SLS. The acceleration period with the gear ratio γ of the continuously variable transmission 18 kept at its maximum gear ratio γmax is assumed to be a vehicle takeoff period for example. Accordingly, the failure determination execution condition establishment determining portion 78 may determine whether the vehicle is taking off.

An electromagnetic valve failure determining means, i.e., an electromagnetic valve failure determining portion 80 is operatively provided with a belt slip presence/absence determining means, i.e., a belt slip presence/absence determining portion 82 that determines whether a belt slip occurs in the continuously variable transmission 18 for example, to execute the electromagnetic valve failure determination based on the result of determination from the belt slip presence/absence determining portion 82.

If it is determined by the failure determination execution condition establishment determining portion 78 to be in acceleration running at the maximum gear ratio γmax, then the belt slip presence/absence determining portion 82 determines whether a belt slip occurs in the continuously variable transmission 18, based on whether the actual gear ratio γ of the continuously variable transmission 18 deviates from the maximum gear ratio γmax. If a belt slip occurs in acceleration running at the maximum gear ratio γmax, then the actual input shaft rotation speed N_{IN} is considered to increase from a conversion value (=γmax×N_{OUT}) of the input shaft rotation speed N_{IN} that is calculated based on the maximum gear ratio γmax and the actual output shaft rotation speed N_{OUT}. Therefore, the belt slip presence/absence determining portion 82 determines whether a belt slip occurs in the continuously variable transmission 18 based on whether the actual gear ratio γ increases from a belt slip determination threshold value γlim (=γmax+α) obtained by adding a margin α to the maximum gear ratio γmax. The margin α is a determination margin that is previously obtained and stored for securely determining the occurrence of a belt slip.

If the actual gear ratio γ increases from the belt slip determination threshold value γlim so that it is determined by the belt slip presence/absence determining portion 82 that a belt slip occurs in the continuously variable transmission 18, then the electromagnetic valve failure determining portion 80 determines that a failure occurs in the electromagnetic valve SLT, SLS and sets an electromagnetic valve failure flag Fsf to “1” with a failure determination execution flag Ffa set to “1”. On the contrary, if it is determined by the belt slip presence/absence determining portion 82 that no belt slip occurs in the continuously variable transmission 18, then the electromagnetic valve failure determining portion 80 determines that no failure occurs in the electromagnetic valve SLT, SLS (i.e., the electromagnetic valve SLT, SLS is normal) and sets the electromagnetic valve failure flag Fsf to “0” with the failure determination execution flag Ffa set to “1”. The failure determination execution flag Ffa is reset to “0” when a vehicle power supply goes from off to on.

The failure determination execution condition establishment determining portion 78 determines, e.g., whether the failure determination execution flag Ffa is set to “1”. The failure determination execution condition establishment determining portion 78 determines, e.g., whether the secondary specified oil pressure Pouttgt is a predetermined specified oil pressure A or more. As depicted in FIG. 6, since the sensor detected pressure PoutS is basically zero or more, the oil pressure drop abnormality determination threshold value Poutlim is equally set to zero within a range of the secondary specified oil pressure Pouttgt where the oil pressure drop abnormality determination threshold value Poutlim is a negative value (a long dashed double-dotted line of FIG. 6). Thus, for a correct determination of the occurrence of the oil pressure drop abnormality, the occurrence of the oil pressure drop abnormality needs to be determined within a range of the secondary specified oil pressure Pouttgt where the oil pressure drop abnormality determination threshold value Poutlim exceeds zero, i.e., within a range where the secondary specified oil pressure Pouttgt is a predetermined specified oil pressure A or more. This determination is one for determining it.

A sensor failure determining means, i.e., a sensor failure determining portion 84 is operatively provided with an oil pressure drop abnormality determining means, i.e., an oil pressure drop abnormality determining portion 86 that determines whether the oil pressure drop abnormality occurs for example, to execute the sensor failure determination based on the result of determination from the electromagnetic valve failure determining portion 80 and on the result of determination from the oil pressure drop abnormality determining portion 86.

If it is determined by the failure determination execution condition establishment determining portion 78 that the secondary specified oil pressure Pouttgt is a predetermined specified oil pressure A or more, then the oil pressure drop abnormality determining portion 86 determines whether an oil pressure drop abnormality occurs that the sensor detected pressure PoutS from the secondary pressure sensor 64 is lower continuously for a predetermined period of time T than the oil pressure drop abnormality determination threshold value Poutlim. The predetermined period of time T is a determination settlement time that is previously obtained and stored, during which the actual secondary pressure Pout is stable in spite of considering a response delay of the oil pressure or a variation in the secondary specified oil pressure Pouttgt, for ensuring a secure determination of the occurrence of an oil pressure drop abnormality.

If it is determined by the oil pressure drop abnormality determining portion 86 that an oil pressure drop abnormality occurs, then the sensor failure determining portion 84 executes the sensor failure determination on condition that the failure determination execution condition establishment determining portion 78 determines that the failure determination execution flag Ffa is set to “1”. For example, the sensor failure determining portion 84 determines that a failure occurs in the secondary pressure sensor 64 if it is determined by the electromagnetic valve failure determining portion 80 that no failure occurs in the electromagnetic valve SLT, SLS (i.e., it is determined that the electromagnetic valve failure flag Fsf is set to “0”) and if it is determined by the oil pressure drop abnormality determining portion 86 that an oil pressure drop abnormality occurs. Reversely, the sensor failure determining portion 84 determines that no failure occurs in the secondary pressure sensor 64 (i.e., the secondary pressure sensor 64 is normal) even if it is determined by the oil pressure drop abnormality determining portion 86 that an oil pressure drop abnormality occurs but if it is determined by the electromagnetic valve failure determining portion 80 that a failure occurs in the electromagnetic valve SLT, SLS (i.e., if the electromagnetic valve failure flag Fsf is set to “1”). On the other hand, the sensor failure determining portion 84 determines that no failure occurs in the secondary pressure sensor 64 (i.e., the secondary pressure sensor 64 is normal) if it is determined by the oil pressure drop abnormality determining portion 86 that no oil pressure drop abnormality occurs.

A notification control means, i.e., a notification control portion 88 stores in a publicly known flash memory 66 (see FIG. 3) for example a history of failures of the electromagnetic valve SLT, SLS determined by the electromagnetic valve failure determining portion 80 and a history of failures of the secondary pressure sensor 64 determined by the sensor failure determining portion 84. When a failure of the electromagnetic valve SLT, SLS is determined by the electromagnetic valve failure determining portion 80 or when a failure of the secondary pressure sensor 64 is determined by the sensor failure determining portion 84, the notification control portion 88 turns on an indicator 68 (see FIG. 3) for notifying the user of the failure for example.

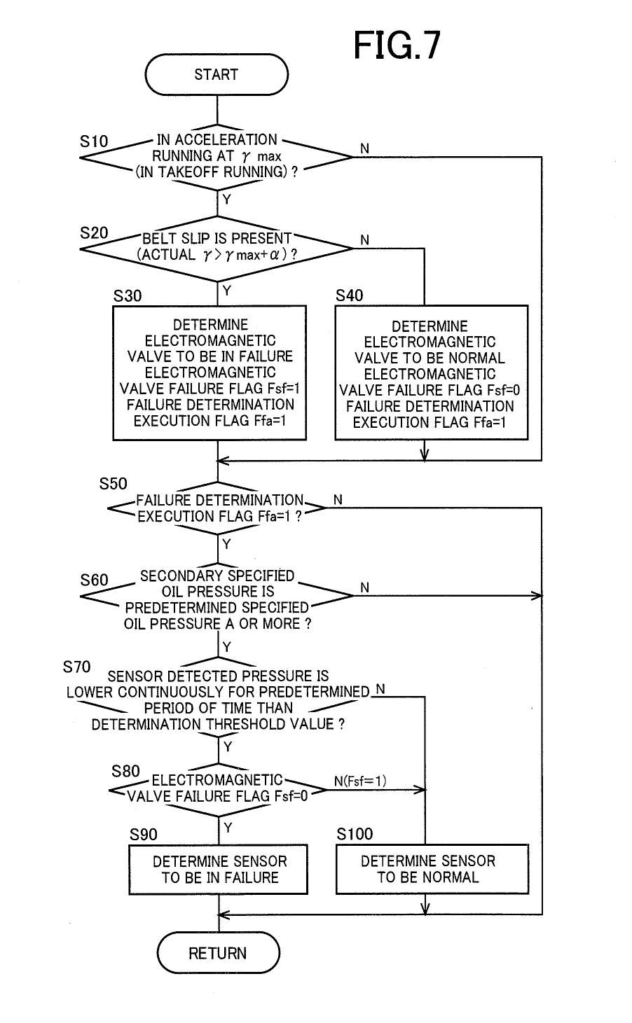

FIG. 7 is a flowchart explaining major control actions of the electronic control device 50, i.e., control actions for preventing a false determination in the failure determination of the electromagnetic valve SLT, SLS and the failure determination of the secondary pressure sensor 64, the flowchart being repeatedly executed at an extremely short cycle time of the order of several milliseconds to several tens of milliseconds for example.

Referring to FIG. 7, first, in step (hereinafter, the word “step” is omitted) S10 corresponding to the failure determination execution condition establishment determining portion 78, it is determined whether the vehicle is in acceleration running (e.g., vehicle in takeoff) with the gear ratio γ of the continuously variable transmission 18 kept at the maximum gear ratio γmax for example. If the determination of S10 is affirmative, then the procedure goes to S20 corresponding to the belt slip presence/absence determining portion 82, at which it is determined whether a belt slip occurs in the continuously variable transmission 18 for example based on whether the actual gear ratio γ is greater than the belt slip determination threshold value γlim (=γmax+α). If the determination of S20 is affirmative, then the procedure goes to S30 corresponding to the electromagnetic valve failure determining portion 80, at which it is determined that a failure occurs in the electromagnetic valve SLT, SLS while the electromagnetic valve failure flag Fsf is set to “1” with the failure determination execution flag Ffa set to “1”. If the determination of S20 is negative, then the procedure goes to S40 corresponding to the electromagnetic valve failure determining portion 80, at which the electromagnetic valve SLT, SLS is determined to be normal while the electromagnetic valve failure flag Fsf is set to “0” with the failure determination execution flag Ffa set to “1”. If the determination of S10 is negative, or, subsequent to S30 or S40, the procedure goes to S50 corresponding to the failure determination execution condition establishment determining portion 78, at which it is determined whether the failure determination execution flag Ffa is set to “1” for example. If the determination of S50 is negative, then the routine is brought to an end, whereas if affirmative, then the procedure goes to S60 corresponding to the failure determination execution condition establishment determining portion 78, at which it is determined for example whether the secondary specified oil pressure Pouttgt is a predetermined specified oil pressure A or more. If the determination of S60 is negative, then this routine is brought to an end, whereas if affirmative, then the procedure goes to S70 corresponding to the oil pressure drop abnormality determining portion 86, at which it is determined for example whether an oil pressure drop abnormality occurs that the sensor detected pressure PoutS from the secondary pressure sensor 64 is lower continuously for a predetermined period of time T than the oil pressure drop abnormality determination threshold value Poutlim. If the determination of S70 is affirmative, then the procedure goes to S80 corresponding to the sensor failure determining portion 84, at which it is determined whether the electromagnetic valve failure flag Fsf is set to “0”. If the determination of S80 is affirmative, then the procedure goes to S90 corresponding to the sensor failure determining portion 84, at which it is determined for example that a failure occurs in the secondary pressure sensor 64. If the determination of S70 is negative or if the determination of S80 is negative as a result of the electromagnetic valve failure flag Fsf being set to “1”, then the procedure goes to S100 corresponding to the sensor failure determining portion 84, at which the secondary pressure sensor 64 is determined to be normal.

According to this embodiment, as described above, after the execution of the electromagnetic valve failure determination for determining whether a failure occurs in the electromagnetic valve SLT, SLS, the sensor failure determination is carried out for determining whether a failure occurs in the secondary pressure sensor 64. This allows the sensor failure determination to be carried out on the basis of the state where the presence/absence of a failure in the electromagnetic valve SLT, SLS has been settled as a result of execution of the electromagnetic valve failure determination, so that it is determined in the state where the presence/absence of a failure in the electromagnetic valve SLT, SLS has already been settled whether a failure in the secondary pressure sensor 64 brings about an abnormal that the sensor detected pressure PoutS is lower than the target secondary pressure Pout*. A false determination can thus be prevented in the failure determination of the electromagnetic valve SLT, SLS and the failure determination of the secondary pressure sensor 64.

According to this embodiment, the electromagnetic valve failure determination determines whether there occurs a slip of the transmission belt 46 and, if the slip of the transmission belt 46 is determined to occur, determines that a failure occurs in the electromagnetic valve SLT, SLS, with the result that it can be properly determined whether a failure occurs in the electromagnetic valve SLT, SLS based on whether there occurs a slip of the transmission belt 46.

According to this embodiment, the electromagnetic valve failure determination determines whether a slip of the transmission belt 46 occurs based on whether the actual gear ratio γ of the continuously variable transmission 18 deviates from the maximum gear ratio γmax in the acceleration running with the gear ratio γ of the continuously variably transmission 18 kept at the maximum gear ratio γmax, whereupon it can be properly determined whether a slip of the transmission belt 46 occurs.

According to this embodiment, the sensor failure determination determines whether there occurs an oil pressure drop abnormality that the sensor detected pressure PoutS is lower continuously for a predetermined period of time T than the oil pressure drop abnormality determination threshold value Poutlim and, if it is determined in the electromagnetic valve failure determination that no failure occurs in the electromagnetic valve SLT, SLS and if the oil pressure drop abnormality is determined to occur, determines that a failure occurs in the secondary pressure sensor 64, whereby it can be definitely discriminated whether the oil pressure drop abnormality is attributable to a failure in the electromagnetic valve SLT, SLS or to a failure in the secondary pressure sensor 64. In other words, it can be definitely discriminated whether the oil pressure drop abnormality originates from a low-pressure-side failure in the electromagnetic valve SLT, SLS that reduces the actual secondary pressure Pout or from a low-pressure-side failure of the secondary pressure sensor 64 itself that the sensor detected pressure PoutS is lower than the proper value (actual secondary pressure Pout). A false determination can thus be securely prevented in the failure determination of the electromagnetic valve SLT, SLS and the failure determination of the secondary pressure sensor 64.

Although the embodiment of the present invention has hereinabove been described in detail with reference to the drawings, the present invention is applicable to the other modes.

For example, in the flowchart of FIG. 7 of the above embodiment, step S50 includes execution of determination of whether the failure determination execution flag Ffa is set to “1”, but the determination may be executed after the affirmation of the determination at step S70. The present invention is applicable also to such a configuration.

In the above embodiment, the oil pressure drop abnormality determination threshold value Poutlim is a predetermined threshold value that is previously obtained and set to be a value lower by a given value than the target secondary pressure Pout*, but this is not limitative. It is considered in the oil pressure drop abnormality attributable to the low-pressure-side failure of the electromagnetic valve SLT, SLS or to the low-pressure-side failure of the secondary pressure sensor 64 that the actual secondary pressure Pout is zero or a value in the vicinity of zero. Accordingly, the oil pressure drop abnormality determination threshold value Poutlim may be a predetermined threshold value that is set to a certain value ensuring determination of an oil pressure drop abnormality that the actual secondary pressure Pout is zero or a value near zero.

Although the oil pressure control circuit 100 of the above embodiment is configured such that the oil pressure fed to the primary-side hydraulic cylinder 42c is directly controlled to obtain a primary pressure Pin, this is not limitative. For example, the present invention is applicable also to an oil pressure control circuit configured to generate the primary pressure Pin as a result of controlling the flowrate of the working oil to the primary-side hydraulic cylinder 42c.

Although the oil pressure control circuit 100 of the above embodiment is provided with the linear solenoid valve SLT that controls the line oil pressure P_{L} and the linear solenoid valve SLS that controls the secondary pressure Pout, this is not limitative. For example, the present invention is applicable also to an oil pressure control circuit having one solenoid valve only of the linear solenoid valve SLT and the linear solenoid valve SLS and configured to control both the line oil pressure P_{L} and the secondary pressure Pout by the one solenoid valve.

Although in the oil pressure control circuit 100 of the above embodiment, the secondary pressure sensor 64 is disposed on the side of the secondary pulley 44, the gear ratio γ of the continuously variable transmission 18 being controlled on the side of the primary pulley 40, the belt clamping force of the continuously variable transmission 18 being controlled on the side of the secondary pulley 44, this is not limitative. For example, the present invention is applicable also to an oil pressure control circuit having the oil pressure sensor on the side of the primary pulley 40 and configured to control the gear ratio γ of the continuously variable transmission 18 on the side of the secondary pulley 44 and to control the belt clamping force of the continuously variable transmission 18 on the side of the primary pulley 40. The target gear ratio may not be implemented by the pulley on one hand and the target belt clamping force may not be implemented by the pulley on the other hand. For example, the present invention is applicable also to an oil pressure control circuit configured to implement the target gear ratio γ* from a mutual relationship between a primary thrust Win and a secondary thrust Wout while preventing a slip of the transmission belt 48 by the primary pressure Pin (identical to the primary thrust Win) and the secondary pressure Pout (identical to the secondary thrust Wout).

Although in the above embodiment the shift of the continuously variable transmission 18 is executed by the feedback control based on a rotation deviation ΔN_{IN}(=N_{IN}*−N_{IN}), use of the rotation deviation ΔN_{IN} as the deviation is merely an example. The point is that this deviation may be a deviation between the target value and the actual value in a parameter one-to-one corresponding to the input shaft rotation speed N_{IN}. For example, in place of the rotation deviation ΔN_{N}, use may be made of a gear ratio deviation Δγ (=γ*−γ) between the target gear ratio γ* and the actual gear ratio γ, a deviation ΔX (=X*−X) between a target pulley position X* and an actual pulley position X, a deviation ΔR (=R*−R) between a target belt engagement diameter R* and an actual belt engagement diameter R, etc.

Although in the above embodiment the belt slip of the continuously variable transmission 18 is determined based on whether the actual gear ratio γ is greater than the belt slip determination threshold value γlim (=γmax+α), this is not limitative. For example, the belt slip of the continuously variable transmission 18 may be determined based on whether the actual input shaft rotation speed N_{IN} is greater than a belt slip determination threshold value obtained by adding a margin β to the conversion value (=γmax X N_{OUT}) of the input shaft rotation speed N_{IN} based on the maximum gear ratio γmax.

Although in the above embodiment the torque converter 14 having the lock-up clutch 26 is used as a fluid-type power transmission device, the lock-up clutch 26 may not necessarily be disposed and the torque converter 14 may be replaced by another fluid-type power transmission device such as a fluid coupling having no torque increasing function. In cases where the forward/backward motion switching device functions as a takeoff mechanism thereof, where the takeoff mechanism such as a takeoff clutch is provided, or where an engagement device, etc. capable of disconnection and connection of the power transmission path is disposed, the fluid-type power transmission device may not be provided.

It is to be understood that the above is merely an embodiment and that the present invention may be carried out in variously changed or improved modes based on the knowledge of those skilled in the art.

### DESCRIPTION OF REFERENCE NUMERALS

18: belt-type continuously variable transmission (vehicle continuously variable transmission)
40: input-side variable pulley
44: output-side variable pulley
46: transmission belt
50: electronic control device (control device)
64: secondary pressure sensor (oil pressure sensor)
SLT, SLS: linear solenoid valve (electromagnetic valve)

What is claimed is:

1. A control device of a vehicle continuously variable transmission, comprising a pair of variable pulleys consisting of an input-side variable pulley and an output-side variable pulley whose effective diameters are variable; a transmission belt wound around the pair of variable pulleys; an electromagnetic valve that controls an oil pressure fed to prevent a slip of the transmission belt; and an oil pressure sensor that detects the oil pressure controlled by the electromagnetic valve, wherein
a sensor failure determination for determining whether a failure occurs in the oil pressure sensor is executed after execution of an electronic valve failure determination for determining whether a failure occurs in the electromagnetic valve.

2. The control device of a vehicle continuously variable transmission of claim 1, wherein
the electromagnetic valve failure determination determines whether a slip of the transmission belt occurs and, if the slip of the transmission belt is determined to occur, determines that a failure occurs in the electromagnetic valve.

3. The control device of a vehicle continuously variable transmission of claim 2, wherein
the electromagnetic valve failure determination determines whether a slip of the transmission belt occurs based on whether an actual value of a gear ratio of the vehicle continuously variable transmission deviates from a lowest-speed-side gear ratio in an acceleration running with the vehicle continuously variable transmission kept at the lowest-speed-side gear ratio.

4. The control device of a vehicle continuously variable transmission of claim 1, wherein
the sensor failure determination determines whether an oil pressure drop abnormality occurs that a detection value of the oil pressure from the oil pressure sensor is lower continuously for a predetermined period of time than a predetermined threshold value that is set to be a value lower by a given value than a target value of the oil pressure and, if it is determined in the electromagnetic valve failure determination that no failure occurs in the electromagnetic valve and if the oil pressure drop abnormality is determined to occur, determines that a failure occurs in the oil pressure sensor.

5. The control device of a vehicle continuously variable transmission of claim 2, wherein
the sensor failure determination determines whether an oil pressure drop abnormality occurs that a detection value of the oil pressure from the oil pressure sensor is lower continuously for a predetermined period of time than a predetermined threshold value that is set to be a value lower by a given value than a target value of the oil pressure and, if it is determined in the electromagnetic valve failure determination that no failure occurs in the electromagnetic valve and if the oil pressure drop abnormality is determined to occur, determines that a failure occurs in the oil pressure sensor.

6. The control device of a vehicle continuously variable transmission of claim 3, wherein
the sensor failure determination determines whether an oil pressure drop abnormality occurs that a detection value of the oil pressure from the oil pressure sensor is lower continuously for a predetermined period of time than a predetermined threshold value that is set to be a value lower by a given value than a target value of the oil pressure and, if it is determined in the electromagnetic valve failure determination that no failure occurs in the electromagnetic valve and if the oil pressure drop abnormality is determined to occur, determines that a failure occurs in the oil pressure sensor.
